(19) United States
(12) Patent Application Publication
(10) Pub. No.: US 2009/0244922 A1
(43) Pub. Date: Oct. 1, 2009

(54) LIGHT PIPE, ILLUMINATION OPTICAL SYSTEM AND IMAGE PROJECTION DEVICE

(75) Inventors: Kazuhiro HAYAKAWA, Nagoya-shi (JP); Yuji IKEDA, Sagamihara-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya-shi, Aichi (JP)

(21) Appl. No.: 12/412,784

(22) Filed: Mar. 27, 2009

(30) Foreign Application Priority Data
Mar. 28, 2008 (JP) 2008-088191

(51) Int. Cl. F21V 7/04; G03B 21/00

(52) U.S. Cl. 362/555; 353/31

(57) ABSTRACT

In a light pipe which allows light from a light source to be incident on the light pipe from an incident opening to be repeatedly reflected on a side wall surface of the light pipe, and to be radiated from a radiation opening, it is possible to radiate illumination light having high directivity and uniform brightness distribution thus radiating light while enhancing utilization efficiency of light. A diffraction portion is formed in a region on an incident opening side of a side wall surface of a light pipe. In the diffraction portion, light is reflected such that a reflection angle with respect to the side wall surface is larger than an incident angle with respect to the side wall surface, and a radiation angle of light radiated from a radiation opening is smaller than an incident angle of light incident on the light pipe from an incident opening.

### CROSS-REFERENCE TO RELATED APPLICATION(S)

This application is based on and claims the benefit of priority from Japanese Patent Application No. 2008-088191 filed on Mar. 28, 2008; the entire contents of which are incorporated herein by reference.

### BACKGROUND

1. Field

The present invention relates to a light pipe which introduces light therein from one end thereof and radiates the light from another end thereof, and an illumination optical system and an image projection device which uses such a light pipe.

2. Description of the Related Art

There has been popularly used an image projection device which radiates light from a light source to an optical modulation element such as a liquid crystal display element or a DMD (digital micro mirror device) element, and projects an image on a screen. As a light source which radiates light to the optical modulation element, a halogen lamp, a high-pressure mercury-vapor lamp or the like has been used. However, such a light source requires large amount of electricity and also requires a cooling device to cope with the elevation of temperature and hence, a weight and a volume of the light source are increased, and such increase of the weight and the volume obstructs the formation of the whole device in a compact shape. On the other hand, recently, brightness and light emitting efficiency of a light emitting diode (LED) are enhanced. The LED requires a low drive voltage and is small-sized and light-weighted and hence, the utilization of the LED as the light source of the image projection device can realize the miniaturization and the reduction of weight of the whole device.

However, light radiated from the LED exhibits low directivity and hence, a reflector and a focusing lens system become necessary, and the brightness of the light in the light radiation direction is not always uniform. When the directivity of the radiation light is low, a ratio of light which can be used in image projection is lowered thus making a projection screen dark. Further, when the brightness irregularities are present with respect to the radiation direction, the brightness irregularities are generated on the projection surface thus lowering image quality. A technique disclosed in JP-A-2005-283918 (patent document 1) is proposed for overcoming such a drawback using a rod integrator (hereinafter referred to as a light pipe).

FIG. 7 shows the cross-sectional structure of an illumination light-source device 50 described in patent document 1. The illumination light-source device 50 is constituted of a light pipe 51, and a white LED 52 arranged at a light incident opening 54 of the light pipe 51. The white LED 52 has a light emitting point 53 thereof arranged more inside in a light guide passage 56 than an end portion of the light pipe 51 and hence, it is possible to efficiently guide light emitted from the light emitting point 53 to the light radiation opening 55. Further, the light pipe 51 is formed in a hollow cylindrical shape and hence, the number of internal reflections of light is increased compared to a case in which a solid columnar-shaped light pipe is used. Accordingly, when light is radiated from the light radiation opening 55, it is possible to acquire illumination light having more uniform intensity.

FIG. 8 shows the cross-sectional structure of an illumination device 60 described in JP-A-2003-330109 (patent document 2). The illumination device 60 is constituted of a plurality of tapered rods 63, a rod 64 which is arranged in front of these tapered rods 63 and is formed by merging radiation-side opening portions of the plurality of tapered rods 63, and an LED array 62 which includes LEDs 68R, 68G, 68B which are mounted on bottoms of the respective tapered rods 63 having a bowl shape and a board 67 on which the respective LEDs are mounted. Lights emitted from the respective LEDs 68R, 68G, 68B are reflected by a wall surface of the tapered rods 63 so that radiation angles of these lights are narrowed and, thereafter, the lights are radiated from a radiation end of the rod 64. Lights of respective colors emitted from the plurality of light sources formed of the LEDs 68R, 68G, 68B are synthesized and hence, white light having the higher directivity can be radiated.

### SUMMARY

In the illumination light-source device 50 described in patent document 1, assume a radiation angle of light emitted from the light emitting point 53 of the white LED 52 as θ, for example. Light emitted from the light emitting point 53 is repeatedly reflected on an inner surface 57 of the light pipe 51, and advances toward the light radiation opening 55. However, when light is reflected on the inner surface 57, an incident angle and a reflection angle are equal. That is, when light which is radiated from the white LED 52 is radiated from the light radiation opening 55, the above-mentioned radiation angle is maintained. Accordingly, assuming the radiation angle of light radiated from the light radiation opening 55 as φ, the radiation angle φ becomes almost equal to the light emission angle θ. Accordingly, in the illumination light source device 50 shown in FIG. 7, the directivity of light which is radiated from the light pipe 51 is not noticeably changed from the directivity of light radiated from the LED 52 which constitutes the light source. Accordingly, a further modification of the illumination light-source device 50 becomes necessary for preventing lowering of utilization efficiency of light. Particularly, in case the illumination light-source device 50 is used in a projector, an allowable incident angle of the projection lens is smaller than a light emission angle of the LED and hence, light radiated from the light pipe at a radiation angle larger than an allowable incident angle is not projected from the projection lens thus causing a loss.

In the illumination device 60 described in patent document 2, lights emitted from the respective LEDs 68R, 68G, 68B are radiated with directivities enhanced by the tapered rods 63 having a reflector function. However, lights emitted from the respective LEDs 68R, 68G, 68B are not repeatedly reflected within the respective tapered rods 63 and, further, the rod 64 which is arranged in front of the tapered rods 63 has a large aperture and hence, the number of repetitious reflections of lights radiated from the tapered rods 63 is small. For example, when lights radiated from the respective LEDs 68R, 68G, 68B have radiation angle dependency, the angle dependency of the radiation light radiated from the rod 64 maintains the angle dependency as it is, and the angle dependency appears as color irregularities on a projected image. In the same manner, when colors of lights emitted from the respective LEDs 68R, 68G, 68B differ from each other, there exists a possibility that color distribution occurs in the light radiated from the rod 64. When the color distribution occurs, quality of a projected image is lowered. Accordingly, it is necessary to cope with such lowering of quality of the projected image by further providing a light mixing unit between the rod 64 and a light modulation element.

According to a first aspect of the present invention, there is provided a light pipe which comprises: a light guide body which includes an incident opening, a radiation opening, and a side wall surface formed of an inner peripheral surface extending from the incident opening to the radiation opening, the light guide body being configured to allow light from a light source to be incident on the light pipe from the incident opening, to be repeatedly reflected on the side wall surface and to be radiated from the radiation opening; and a diffraction portion which is formed in a region of the sidewall surface on an incident opening side such that a radiation angle of the light radiated from the radiation opening is smaller than an incident angle of the light which is incident on the light pipe from the incident opening.

According to a second aspect of the present invention, there is provided an illumination optical system which comprises: i) a light pipe which includes: a light guide body which includes an incident opening, a radiation opening, and a side wall surface formed of an inner peripheral surface extending from the incident opening to the radiation opening, the light guide body being configured to allow light from a light source to be incident on the light pipe from the incident opening, to be repeatedly reflected on the side wall surface and to be radiated from the radiation opening; and a diffraction portion which is formed in a region of the side wall surface on an incident opening side such that a radiation angle of the light radiated from the radiation opening is smaller than an incident angle of the light which is incident on the light pipe from the incident opening; and ii) a light source which is hermetically arranged in the incident opening of the light pipe.

According to a third aspect of the present invention, there is provided an image projection device which comprises: a plurality of illumination optical systems corresponding to three primary colors respectively; a light synthesizing part which is configured to synthesize lights radiated from the illumination optical systems; a light modulation part which is configured to modulate light synthesized by the light synthesizing part: and a projection part which projects light modulated by the light modulation part, wherein each illumination optical system comprises: i) alight pipe which includes: a light guide body which includes an incident opening, a radiation opening, and a side wall surface formed of an inner peripheral surface extending from the incident opening to the radiation opening, the light guide body being configured to allow light from a light source to be incident on the light pipe from the incident opening, to be repeatedly reflected on the side wall surface and to be radiated from the radiation opening; and a diffraction portion which is formed in a region of the side wall surface on an incident opening side such that a radiation angle of the light radiated from the radiation opening is smaller than an incident angle of the light which is incident on the light pipe from the incident opening; and ii) a light source which is hermetically arranged in the incident opening of the light pipe.

### BRIEF DESCRIPTION OF THE DRAWINGS

FIG. 1 is a schematic longitudinal cross-sectional view of a light pipe according to an embodiment of the present invention;

FIG. 2A and FIG. 2B are explanatory views of the light pipe according to the embodiment of the present invention;

FIG. 3 is an explanatory view of the light pipe according to the embodiment of the present invention;

FIG. 4A and FIG. 4B are schematic longitudinal cross-sectional views of illumination optical systems according to the embodiment of the present invention;

FIG. 5 is a schematic cross-sectional view of an image projection device according to the embodiment of the present invention;

FIG. 6 is a schematic cross-sectional view of an image projection device according to the embodiment of the present invention;

FIG. 7 is a cross-sectional view of a conventionally known illumination light-source device; and

FIG. 8 is across-sectional view of a conventionally known illumination device.

### DETAILED DESCRIPTION

Hereinafter, the constitution of the present invention is explained in detail in conjunction with attached drawings.

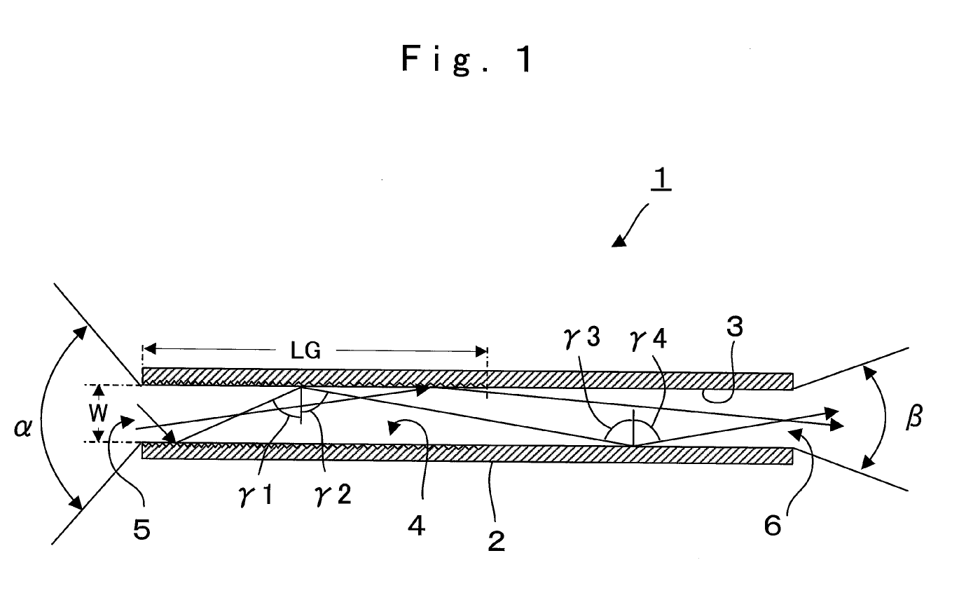

FIG. 1 is a schematic longitudinal cross-sectional view showing the constitution of a light pipe 1 according to an embodiment of the present invention. The light pipe 1 is formed of a light guide body 2 having a cylindrical shape and having a hollow inside. An inner wall surface of the light guide body 2 forms a side wall surface 3, and the side wall surface 3 is constituted of a reflection surface which reflects light. The light guide body 2 allows the incidence of light therein from an incident opening 5 and radiates the incident light from a radiation opening 6. A diffraction portion 4 is formed on the side wall surface 3 of the light guide body 2 on an incident opening 5 side. Assuming a maximum angle of an optical flux which is incident on the light pipe 1 in a spreading manner as an incident angle α, light which is incident on the light pipe 1 at the incident angle α is diffracted toward a radiation opening 6 side in the diffraction portion 4. In the diffraction portion 4, in accordance with a diffraction condition of the diffraction portion 4, light incident at an incident angle γ1 is reflected at a reflection angle γ2 larger than the incident angle γ1. On the side wall surface 3 other than the diffraction portion 4, an incident angle γ3 and a reflection angle γ4 are equal. Accordingly, assuming a maximum angle of an optical flux which is radiated with a width as a radiation angle β, the radiation angle β becomes smaller than the incident angle α.

As a material of the light guide body 2, an inorganic material such as glass, a resin material such as plastic, a metal material, a ceramics material and the like can be used. On the side wall surface 3 of the light guide body 2, a reflection film formed of a metal thin film such as a metal film made of Ag, Al or the like, for example, or a dielectric multi-layered film is formed. The light guidebody 2 maybe formed in a cylindrical shape having a circular or elliptical cross-section or may be formed in a polygonal cylindrical shape. Depending on a device which requires a uniform planner or surface light source, a shape of the light guide body 2 may be set. For example, to radiate light to an optical modulation element having a quadrangular display effective screen, a cross-section of the light guide body 2 in a lateral direction is formed in a quadrangular shape. Due to such constitution, it is possible to acquire radiation light having high directivity and high uniformity in in-plane brightness distribution.

The diffraction portion 4 is formed along the side wall surface 3 in an incident-opening-5-side region of the light guide body 2 or on a portion of the side wall surface 3. A shape of the diffraction portion 4 may be formed of concave or V-shaped grooves or projections having a convex shape or triangular or serrated cross-sectional shape. These shapes may be determined such that diffraction efficiencies of one or a plurality of order lights from which diffraction light is taken out in a diffraction grating formula can be maximized. These grooves or projections may be formed such that the grooves or the projections have a pattern of diffraction grating or hologram. For example, as an example of intervals of the diffraction grating, to enhance directivity of light incident on the incident opening at an incident angle α of 80° by setting the radiation angle β which is an angle for radiation of the light from the radiation opening to 15° or less, assuming a refractive index n to 1, the incident angle with respect to the wall surface as θin, and a reflection angle with respect to the wall surface as θ, an interval size of approximately 0.67 μm becomes necessary from a formula p (nsinθ−sinθin)=mλ (m being integer), wherein m is 1. Further, when the reflection constituted of diffractions of several times is performed, an interval may be set such that the radiation angle becomes 15° or less as a sum of reflections by diffractions of several times.

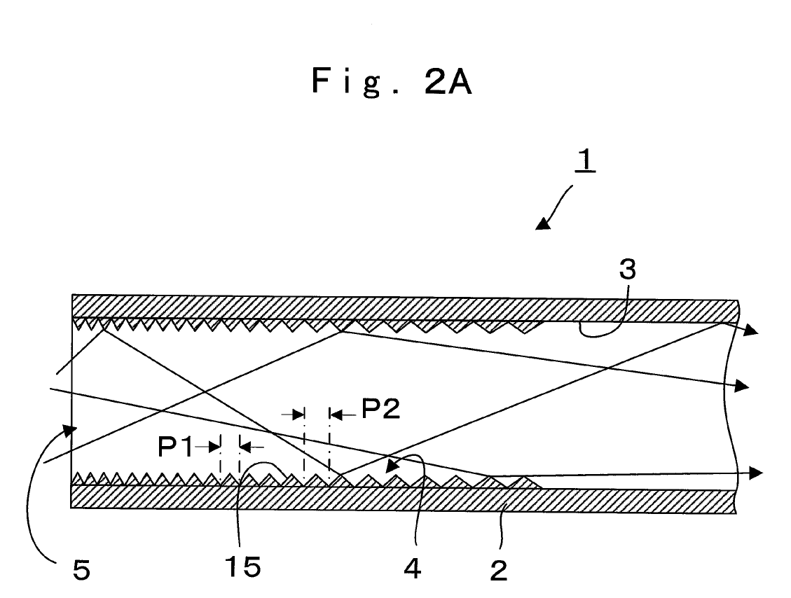

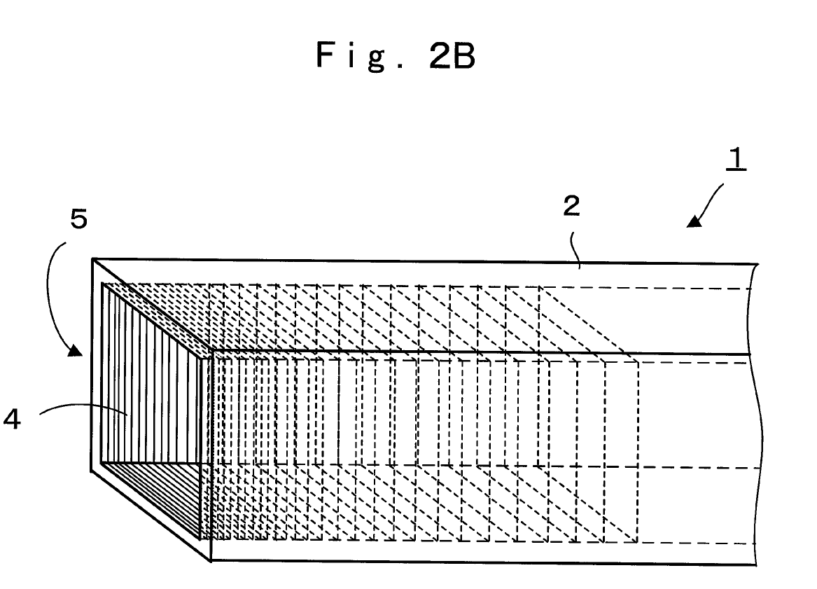

FIG. 2 is an explanatory view showing the diffraction portion 4 of the light pipe 1 according to the embodiment of the present invention. FIG. 2A is a schematic partial cross-sectional view of the incident-opening-5-side region of the light pipe 1, and FIG. 2B is a schematic perspective view of the incident-opening-5-side region of the light pipe 1.

As shown in FIG. 2A and FIG. 2B, the light pipe 1 is constituted of the light guide body 2 having a quadrangular cylindrical shape. The inside of the light guide body 2 is hollow, and the side wall surface 3 formed of the inner wall surface of the light guide body 2 is constituted of the reflection surface. The diffraction portion 4 is formed on the side wall surface 3 in the incident-opening-5-side region of the light guide body 2. The diffraction portion 4 is constituted of a large number of diffraction grooves 15. The diffraction grooves 15 a reformed along the circumference in the direction orthogonal to a longitudinal direction of the light guide body 2. With respect to intervals of the diffraction grooves 15, intervals P1 on the incident opening 5 side is set smaller than intervals P2 on the radiation opening 6 side. That is, the closer the grooves 15 to the incident opening 5, the smaller the intervals of the diffraction grooves 15 become. Accordingly, in the vicinity of the incident opening 5, lights which are incident at the large incident angle α repeat the reflection thereof so that the lights are mixed with each other. On the other hand, the remoter a portion of the side wall surface 3 from the incident opening 5, a reflection angle at which the light is reflected on the sidewall surface 3 is increased. Then, the lights are converted into reflection lights substantially parallel to the longitudinal direction of the light guide body 2, and are radiated from the radiation opening 6 at the small radiation angle β.

Particularly, out of light which is incident on the incident opening 5 of the light guide body 2, the larger the incident angle α of the light, the light is incident on a portion of the diffraction portion 4 closer to the incident opening 5. The diffraction portion 4 near the incident opening 5 has narrower intervals of the diffraction grooves 15 than the diffraction portion 4 near the radiation opening 6 side and hence, the light receives a stronger diffraction action and is largely bent toward the radiation opening 6 side. Here, assuming a length of the diffraction portion 4 in a longitudinal direction of the light guide body 2 as LG, a width of the incident opening 5 as W and calculating the length LG using a formula LG=W/(tan(β/2)), light which is incident on the incident opening 5 of the light guide body 2 at an angle larger than the radiation angle β never fails to be incident on the diffraction portion 4 and hence, it is possible to make the light to be radiated from the radiation opening 6 at the small radiation angle β.

Accordingly, it is unnecessary to make a cross-sectional area of the light guide body 2 in a direction orthogonal to a longitudinal direction of the light guide body 2 small on the incident opening 5 side and large on the radiation opening 6 side. Since the radiation area of the radiation opening 6 can be made small, it is possible to obtain the radiation of light which is similar to the radiation of light from a spot light, has the uniform brightness distribution on a radiation surface, and has high directivity.

Here, with respect to the diffraction grooves 15 in the above-mentioned embodiment, as shown in FIG. 2B, the diffraction grooves 15 are formed at the same intervals on the side wall surfaces 3 of left and right side walls of the light guide body 2 and on the side wall surfaces 3 of upper and lower side walls of the light guide body 2. However, the present invention is not limited to such constitution. For example, the intervals of the diffraction grooves 15 formed on side wall surfaces 3 of left and right side walls of the light guide body 2 and the intervals of the diffraction grooves 15 formed on side wall surfaces 3 of upper and lower side walls of the light guide body 2 may be set different from each other. Due to such constitution, it is possible to radiate the light having the uniform brightness distribution in the lateral direction as well as in the vertical direction at the radiation opening 6. Further, as the diffraction grooves 15, a hologram diffraction pattern may be used in place of parallel grooves. The hologram diffraction pattern is particularly effective when the light has intensity distribution in a radial direction where the light incident from the incident opening 5 is radiated from a point light source.

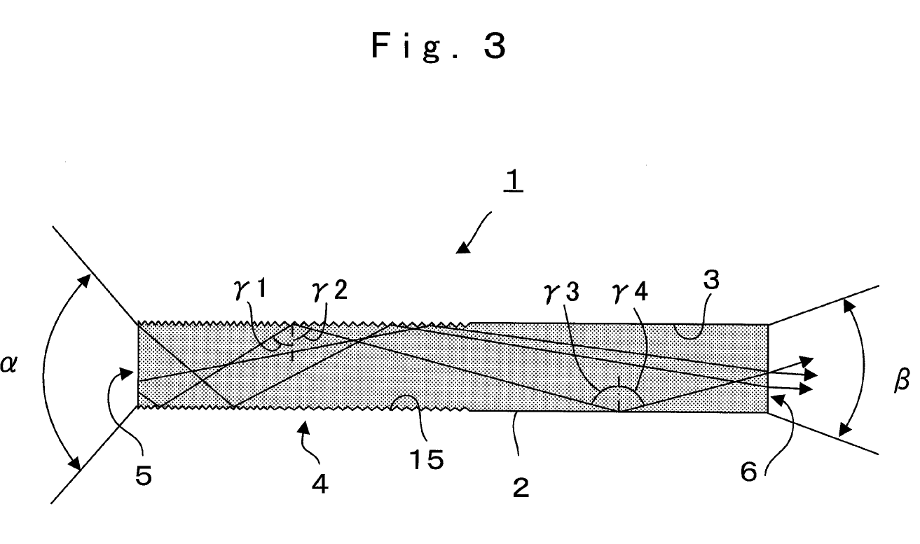

FIG. 3 is a schematic longitudinal cross-sectional view showing the constitution of the light pipe 1 according to another embodiment of the present invention. Parts identical with the parts in the previous embodiment or parts having identical functions with the parts in the previous embodiment are given same symbols. The light pipe 1 is formed of a columnar solid light guide body 2. An outer wall surface of the light guide body 2 constitutes a side wall surface 3. The light guide body 2 allows the incidence of light therein from an incident opening 5 and radiates the incident light from a radiation opening 6. A diffraction portion 4 is formed on the side wall surface 3 of the light guide body 2 on an incident opening 5 side. Light which is incident on the light pipe 1 at an incident angle α is reflected toward a radiation opening 6 side in the diffraction portion 4. In the diffraction portion 4, in accordance with a diffraction condition of the diffraction portion 4, light incident at an incident angle γ1 is reflected at a reflection angle γ2 larger than the incident angle γ1. On the side wall surface 3 other than the diffraction portion 4, an incident angle γ3 and a reflection angle γ4 are equal. Accordingly, a radiation angle β becomes smaller than the incident angle α.

The diffraction portion 4 is constituted of diffraction grooves 15 which are formed of concave or V-shaped grooves or projections having a convex shape or triangular or serrated cross-sectional shape. The diffraction grooves 15 are formed on an outer periphery of the light guide body 2 in the direction orthogonal to the longitudinal direction of the light guide body 2. With respect to intervals of the diffraction grooves 15, the intervals on the incident opening 5 side may be set smaller than the intervals on the radiation opening 6 side. That is, the closer the diffraction grooves 15 to the incident opening 5, the smaller the intervals of the diffraction grooves 15 become. Accordingly, lights which are incident at the large incident angle α from the incident opening 5 repeat the reflection thereof at a reflection angle with respect to a wall surface larger than an incident angle α with respect to the wall surface so that the lights are mixed together. The remoter a region of the diffraction portion 4 from the incident opening 5, the closer the reflection angle at which light is reflected on the side wall surface 3 to the wall surface incident angle. Further, when the solid light guide body 2 is adopted as in the case of this embodiment, light is refracted when the incident light is incident on the light guide body 2 and hence, the incident angle α becomes small in appearance. Accordingly, for example, ablaze angle of the diffraction groove 15 can be decreased thus easing the formation of the diffraction groove 15.

Particularly, out of light which is incident on the incident opening 5 of the light guide body 2, the larger the incident angle α of the light, the light is incident on a portion of the diffraction portion 4 closer to the incident opening 5. The diffraction portion 4 near the incident opening 5 has narrower intervals of the diffraction grooves 15 than the diffraction portion 4 near the radiation opening 6 side and hence, the light diffracted by a stronger diffraction action and is largely bent toward the radiation opening 6 side. Here, assuming a length of the diffraction portion 4 in a longitudinal direction of the light guide body 2 as LG, a width of the incident opening 5 as W and calculating the length LG using a formula LG=W/(tan(β/2)), light which is incident on the incident opening 5 of the light guide body 2 at an angle larger than the radiation angle β never fails to be incident on the diffraction portion 4 and hence, it is possible to make the light to be radiated from the radiation opening 6 at the small radiation angle β.

Further, by adopting a polygonal shape as a profile of the light guide body 2, the intervals of the diffraction grooves 15 may be set different between the side wall surfaces 3 corresponding to neighboring sides of the polygonal shape. For example, when a cross-section of the light guide body 2 in the direction orthogonal to the longitudinal direction of the light guide body 2 is a rectangular shape, the intervals of the diffraction grooves 15 may be set different between the side wall surface 3 on a short side of the rectangular shape and the side wall surface 3 on a long side of the rectangular shape. By properly setting the intervals of the diffraction grooves 15 formed on respective side walls, it is possible to acquire the uniform brightness distribution of light in the short-side direction as well as in the long-side direction at the radiation opening 6. Further, as the diffraction grooves 15, a hologram diffraction pattern may be used in place of parallel grooves. The hologram diffraction pattern is particularly effective when the light has intensity distribution in a radial direction where the light incident from the incident opening 5 is radiated from a point light source. Further, the cross section of the diffraction grooves 15 is not limited to a triangular shape or a V shape, and may be rectangular-shaped concaves and convexes or a semicircular shape.

The light guide body 2 may be formed using an inorganic material such as glass or a resin material such as plastic. With respect to the side wall surface 3 of the light guide body 2 which constitutes the outer wall surface, on at least a region in which the diffraction portion 4 is formed, a reflection film made of Ag, Al or the like, for example, is formed. However, it is not always necessary to form such a reflection film on portions of the side wall surface 3 other than the diffraction portion 4. This is because light is totally reflected on the side wall surface 3 so that light can be confined in the inside of the light guide body 2. Further, the light guide body 2 can be formed in a columnar shape besides the polygonal shape. The shape of the light guide body 2 is determined corresponding to a device which requires a uniform surface light source. For example, in case of radiating light to an optical modulation element having a quadrangular display effective screen, a cross section in a lateral direction of the light guide body 2 may be formed in a quadrangular shape.

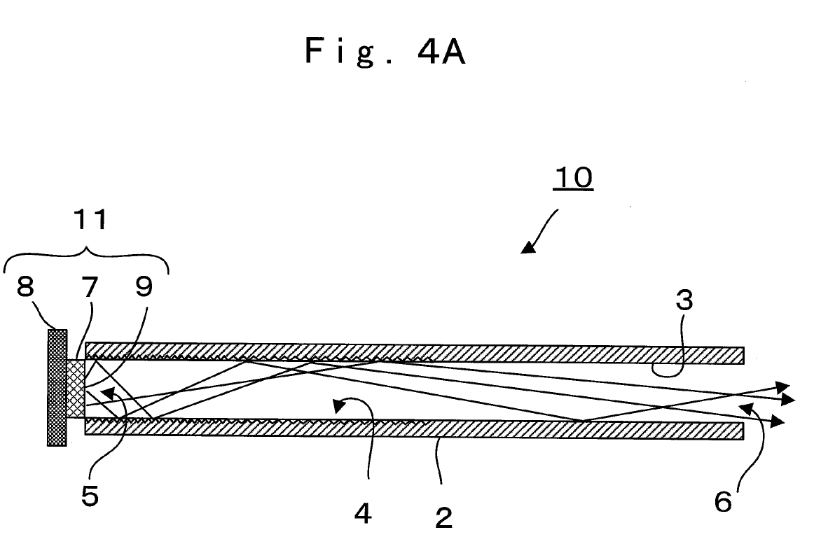

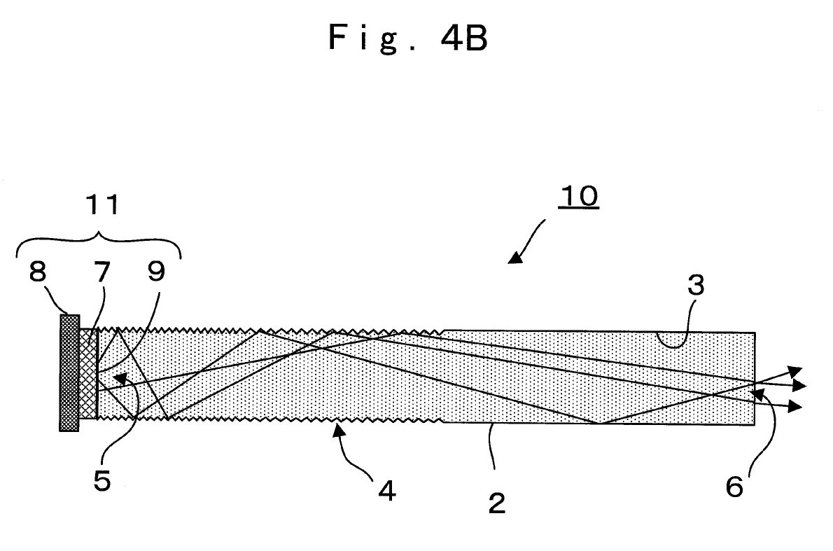

FIG. 4A and FIG. 4B are schematic longitudinal cross-sectional views showing an illumination optical system 10 according to the embodiment of the present invention. FIG. 4A shows the illumination optical system 10 in which the light guide body 2 has a hollow cylindrical shape, and FIG. 4B shows the illumination optical system 10 in which the light guide body 2 is formed in a solid columnar shape. A light emitting element 11 is arranged at an incident opening 5 of each light guide body 2. Parts identical with the parts in the previous embodiment or parts having identical functions with the parts in the previous embodiment are given same symbols.

As shown in FIG. 4A, the light emitting element 11 is arranged at the incident opening 5 of a light pipe 1 formed of the light guide body 2. A space surrounded by a sidewall surface 3 formed of an inner wall surface of the light guide body 2 has an approximately same cross-sectional shape in a direction orthogonal to the longitudinal direction of the light guide body 2. Since the light pipe 1 has the same constitution as the light pipe 1 explained in conjunction with FIG. 1 and FIG. 2, the explanation of the light pipe 1 is omitted. Further, as shown in FIG. 4B, the light emitting element 11 is arranged at an incident opening 5 of a light pipe 1 formed of the light guide body 2. A region surrounded by a side wall surface 3 formed of an outer wall surface of the light guide body 2 has an approximately same cross-sectional shape in a direction orthogonal to the longitudinal direction of the light guide body 2. Since the light pipe 1 has the same constitution as the light pipe 1 explained in conjunction with FIG. 3, the explanation of the light pipe 1 is omitted.

The light emitting element 11 is constituted of a base body 8 and an LED 7 mounted on the base body 8. A radiation surface 9 of the LED 7 from which light is radiated has a shape substantially equal to a shape of the incident opening 5 of the light guide body 2, and is formed on the incident opening 5 hermetically. Accordingly, light radiated from the radiation surface 9 is introduced into the inside of the light guide body 2 without leaking to the outside. Light which is introduced into the inside of the light guide body 2 is reflected toward a radiation opening 6 side by a diffraction portion 4 so that light is converted into a radiation light which exhibits high directivity and, at the same time, exhibits high uniformity in brightness distribution at a radiation opening 6. Further, light which is radiated in an oblique direction from the radiation surface 9 is also used as radiation light and hence, the utilization efficiency of light can be enhanced. Further, by making a refractive index of the solid light guide body 2 shown in FIG. 4B and a refractive index of the LED 7 match with each other, it is possible to reduce a reflection loss on a surface of the incident opening 5 and a light emission surface of the LED 7.

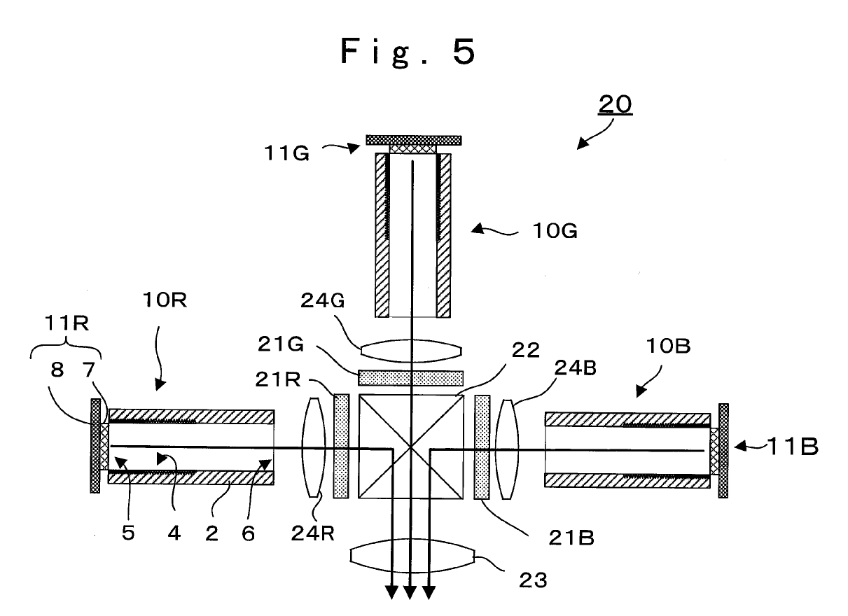

FIG. 5 is a schematic cross-sectional view of the image projection device 20 according to the embodiment of the present invention. The image projection device 20 is constituted of a light synthesizing part 22, optical modulation parts 21R, 21G, 21B arranged at three sides of the light synthesizing part 22, three relay lenses 24R, 24G, 24B which are arranged respectively corresponding to three optical modulation parts 21R, 21G, 21B, three illumination optical systems 10R, 10G, 10B which are arranged respectively corresponding to three relay lenses 24R, 24G, 24B, and a projection part 23. Here, the light synthesizing part 22 is constituted of a dichroic prism. The optical modulation part 21R is formed of a liquid crystal display element which displays an image of red color, the optical modulation part 21G is formed of a liquid crystal display element which displays an image of green color, and the optical modulation part 21B is formed of a liquid crystal display element which displays an image of blue color. Three illumination optical systems 10R, 10G, 10B are respectively provided with a red light emitting element 11R formed of the LED 7 capable of emitting red light, a green light emitting element 11G formed of the LED 7 capable of emitting green light, and a blue light emitting element 11B formed of the LED 7 capable of emitting blue light at the respective incident openings 5 of the light pipes 1 constituted of the light guide body 2. The projection part 23 is constituted of a projection lens system for image projection.

A radiation opening 6 of each illumination optical systems 10R, 10G, 10B has a face shape similar to a shape of a display effective region of each optical modulation part 21R, 21G, 21B. When the display effective region of each optical modulation part 21R, 21G, 21B has a quadrangular shape and an aspect ratio of the quadrangular shape is 3:4, for example, each illumination optical system 10R, 10G, 10B also has a quadrangular shape, and an aspect ratio of the quadrangular radiation opening 6 is also set to 3:4. A diffraction portion 4 which is constituted of diffraction grooves is formed on a side wall surface 3 of the light guide body 2 on an incident opening 5 side. The closer the diffraction grooves to the incident opening 5 side, the smaller intervals of the diffraction grooves become. Further, the diffraction grooves formed in inner surfaces of left and right side walls of each illumination optical system 10R, 10G, 10B and the diffraction grooves formed in inner surfaces of upper and lower side walls of each illumination optical system 10R, 10G, 10B differ in an interval between the neighboring diffraction grooves. Further, the intervals of the diffraction grooves of the respective illumination optical systems 10R, 10G, 10B may be also set different from each other in conformity with colors of emitting lights of the respective light emitting elements 11R, 11G, 11B.

Lights which are respectively radiated from the respective illumination optical systems 10R, 10G, 10B are radiated to the respective optical modulation parts 21R, 21G, 21B as approximately parallel illumination light via respective relay lenses 24R, 24G, 24B. The respective optical modulation parts 21R, 21G, 21B convert the incident illumination light into image lights corresponding to respective colors. The image lights which are radiated from the respective optical modulation parts 21R, 21G, 21B are mixed with each other based on additive color mixture by the light synthesizing part 22, and a synthesized image light is projected on a screen or the like by way of the projection part 23. Due to such constitution, it is possible to provide the image projection device 20 which exhibits high light utilization efficiency, and is light-weighted and compact. Here, in place of radiating the substantially parallel light to the respective optical modulation parts 21R, 21G, 21B from the respective relay lenses 24R, 24G, 24B, it may be possible to radiate optical fluxes which match an incident numerical aperture of the projection lens.

In the above-mentioned embodiment, the relay lenses 24R, 24G, 24B are arranged between the respective illumination optical systems 10R, 10G, 10B and the respective optical modulation parts 21R, 21G, 21B. However, by removing these relay lenses 24R, 24G, 24B, the respective illumination optical systems 10R, 10G, 10B may be arranged close to the respective optical modulation parts 21R, 21G, 21B corresponding to the respective illumination optical systems 10R, 10G, 10B. In this case, a shape of the radiation opening 6 of each illumination optical system 10R, 10G, 10B and a display effective region of each optical modulation part 21R, 21G, 21B may have a substantially equal face shape. Further, although a case in which the hollow light guide body 2 shown in FIG. 4A is used as the illumination optical systems 10R, 10G, 10B is explained, it is possible to use the solid light guide body 2 shown in FIG. 4B in place of the hollow light guide body 2 shown in FIG. 4A.

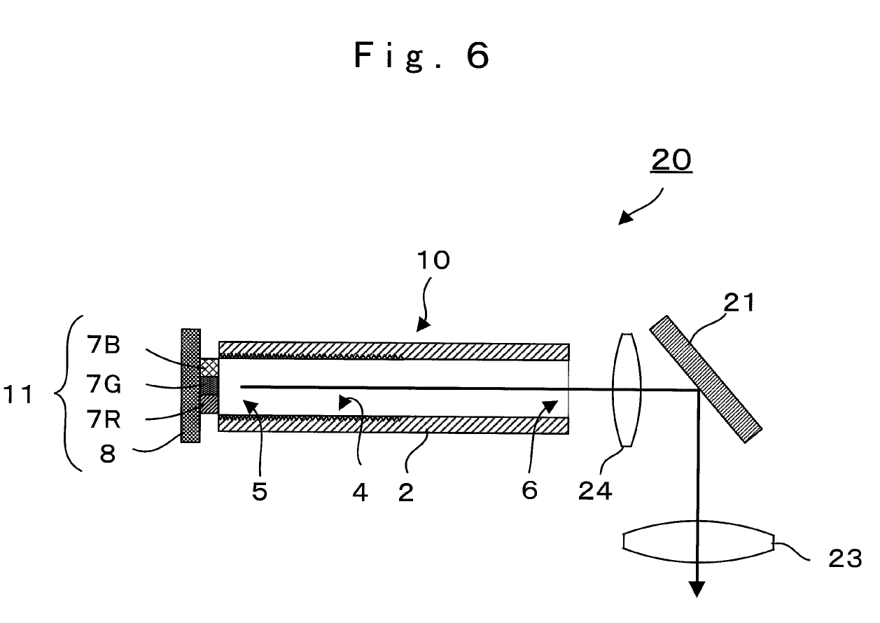

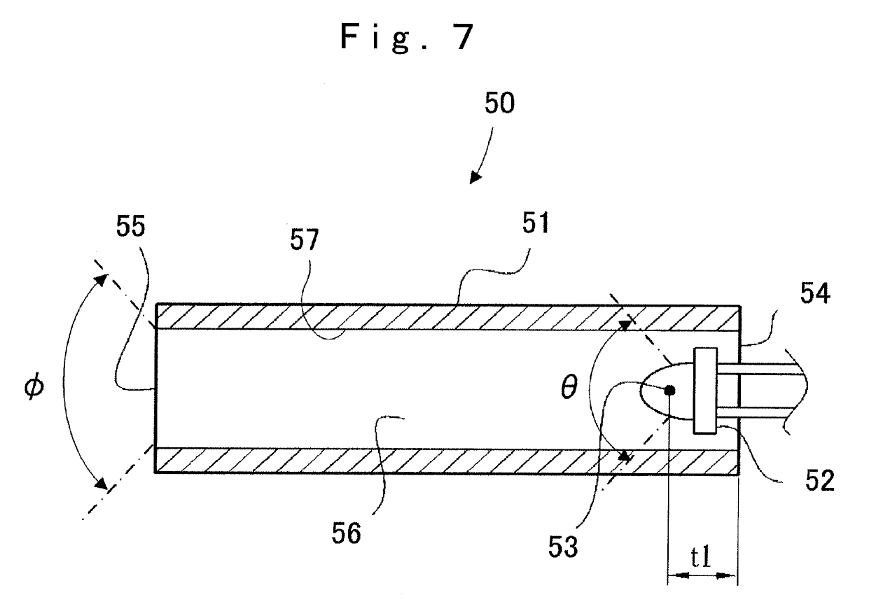

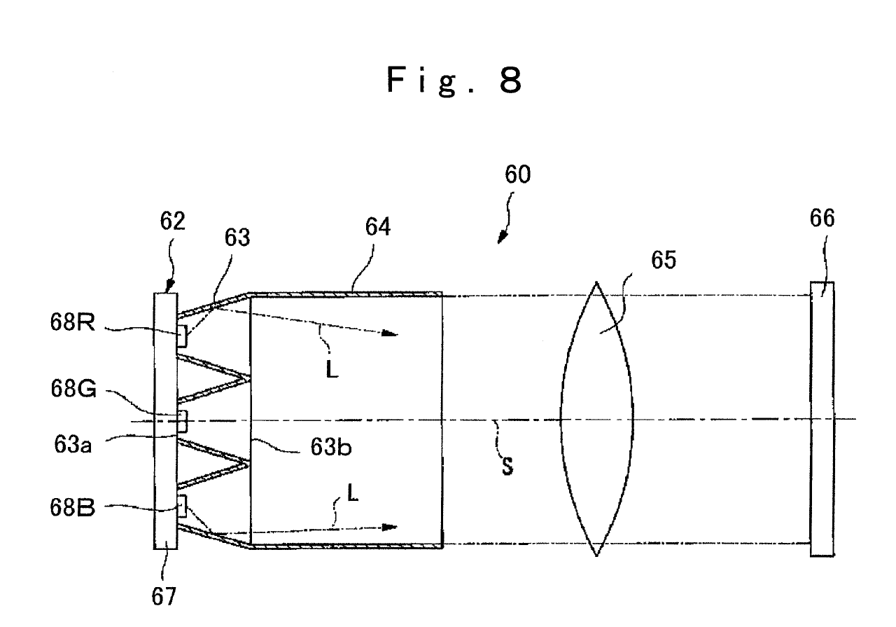

FIG. 6 is a schematic cross-sectional view of an image projection device 20 according to another embodiment of the present invention. Parts identical with the parts in the previous embodiment or parts having identical functions with the parts in the previous embodiment are given same symbols. In FIG. 6, the image projection device 20 includes an illumination optical system 10, a relay lens 24, a reflective optical modulation part 21, and a projection part 23 which projects an image light reflected from the optical modulation part 21. The illumination optical system 10 is constituted of a light guide body 2 and a light emitting element 11 formed on an incident opening 5 of the light guide body 2. The light emitting element 11 is constituted of a base body 8, an LED 7R capable of emitting red light which is mounted on the base body 8, an LED 7G capable of emitting green light which is mounted on the base body 8, and an LED 7B capable of emitting blue light which is mounted on the base body 8. The respective LEDs 7R, 7G, 7B are mounted on the base body 8 in an integrated manner, and a total light emitting surface of the LEDs 7R, 7G, 7B has a shape substantially equal to a shape of an incident surface of the incident opening 5, and is hermetically mounted on an end portion of the light guide body 2. Accordingly, lights emitted from the respective LEDs 7R, 7G, 7B do not leak to the outside. Lights of respective colors emitted from the respective LEDs 7R, 7G, 7B repeat the reflection thereof in the diffraction portion 4 and the side wall surface 3 of the light guide body 2, and the lights are converted into radiation light which exhibits uniform brightness distribution and high directivity at the radiation surface of the radiation opening 6.

The optical modulation part 21 is constituted of a DMD element. The DMD element is formed of a large number of micro mirrors which are rotatable in response to image signals. Light radiated from the illumination optical system 10 is radiated to the DMD element via the relay lens 24, is reflected corresponding to a display image by the large number of micro mirrors of the DMD element, and is projected on a screen or the like by way of the projection part 23 which is constituted of a lens system.

The DMD element is operated as follows. A light source drive circuit which drives the light emitting element 11 drives the respective LEDs 7R, 7G, 7B by time division thus sequentially emitting lights of red, green and blue. A display drive circuit which drives the DMD element sequentially displays an image of red, an image of green and an image of blue to the DMD element in synchronism with the above-mentioned time-division driving. Accordingly, the respective images of red, green, blue are sequentially projected from the projection part 23, and a viewer can recognize a normal image due to color mixing of these images.

As shown in FIG. 5, in the color mixing method which is performed using the illumination optical systems 10 for different colors, lights of different colors which are radiated from the illumination optical systems 10 are synthesized using the light synthesizing part 22, the mixed color lights may be radiated to the reflective optical modulation parts 21 via the relay lenses 24, and lights modulated by the optical modulation parts 21 are projected by the projection part 23. In this case, the illumination optical system 10 may be configured to correspond to respective three primary colors. Further, although the relay lens 24 is arranged in a gap between the illumination optical system 10 and the optical modulation part 21 in FIG. 6, such a relay lens 24 may be omitted. Further, as the optical modulation part 21, a reflective liquid crystal display element maybe used in place of the DMD element. Still further, although the case in which the hollow light guide body 2 shown in FIG. 4A is used as the illumination optical system 10 is explained, the solid light guide body 2 shown in FIG. 4B may be used in place of the hollow light guide body 2 shown in FIG. 4A.

What is claimed is:

1. A light pipe comprising:
a light guide body which includes an incident opening, a radiation opening, and a side wall surface formed of an inner peripheral surface extending from the incident opening to the radiation opening, the light guide body being configured to allow light from a light source to be incident on the light pipe from the incident opening, to be repeatedly reflected on the side wall surface and to be radiated from the radiation opening; and
a diffraction portion which is formed in a region of the side wall surface on an incident opening side such that a radiation angle of the light radiated from the radiation opening is smaller than an incident angle of the light which is incident on the light pipe from the incident opening.

2. A light pipe according to claim 1, wherein the diffraction portion includes a plurality of diffraction grooves, and the closer the diffraction portion to the incident opening, the smaller an interval between two neighboring diffraction grooves out of the plurality of diffraction grooves becomes.

3. A light pipe according to claim 1, wherein the light source is an LED, and a cross-sectional shape of a space surrounded by the side wall surface is approximately equal to a shape of a radiation surface of the LED.

4. A light pipe according to claim 3, wherein the cross-sectional shape is a polygonal shape, and an interval between the neighboring diffraction grooves out of the plurality of diffraction grooves differs between diffraction portions formed on regions of at least one set of neighboring side wall surfaces on the incident opening side.

5. An illumination optical system comprising:
i) a light pipe comprising:
a light guide body which includes an incident opening, a radiation opening, and a side wall surface formed of an inner peripheral surface extending from the incident opening to the radiation opening, the light guide body being configured to allow light from a light source to be incident on the light pipe from the incident opening, to be repeatedly reflected on the side wall surface and to be radiated from the radiation opening; and
a diffraction portion which is formed in a region of the side wall surface on an incident opening side such that a radiation angle of the light radiated from the radiation opening is smaller than an incident angle of the light which is incident on the light pipe from the incident opening; and
ii) a light source which is hermetically arranged in the incident opening of the light pipe.

6. An image projection device comprising:
a plurality of illumination optical systems corresponding to three primary colors respectively;
a light synthesizing part which is configured to synthesize lights radiated from the illumination optical systems;
a light modulation part which is configured to modulate light synthesized by the light synthesizing part: and
a projection part which projects light modulated by the light modulation part, wherein
each illumination optical system comprises:
i) a light pipe comprising:
a light guide body which includes an incident opening, a radiation opening, and a side wall surface formed of an inner peripheral surface extending from the incident opening to the radiation opening, the light guide body being configured to allow light from a light source to be incident on the light pipe from the incident opening, to be repeatedly reflected on the side wall surface and to be radiated from the radiation opening; and
a diffraction portion which is formed in a region of the side wall surface on an incident opening side such that a radiation angle of the light radiated from the radiation opening is smaller than an incident angle of the light which is incident on the light pipe from the incident opening; and
ii) a light source which is hermetically arranged in the incident opening of the light pipe.
